(19) United States
(12) Patent Application Publication
(10) Pub. No.: US 2015/0182952 A1
(43) Pub. Date: Jul. 2, 2015

(54) OBTENTION OF LOW LOADING CATALYSTS FOR DEEP HYDROCARBONS HYDRODESULFURIZATION BASED OF CoMoS, WITH NiMoS HYDRODENITROGENANT ADDITIVE, SUPPORTED ON THREE-DIMENSIONAL NANOSTRUCTURED MESOPOROUS MATERIALS

(71) Applicants: Lorena Alvarez Contreras, Chihuahua (MX); Alfredo Aguilar Elguezabal, Chihuahua (MX); Abril Ibarra Martinez, Chihuahua (MX)

(72) Inventors: Lorena Alvarez Contreras, Chihuahua (MX); Alfredo Aguilar Elguezabal, Chihuahua (MX); Abril Ibarra Martinez, Chihuahua (MX)

(21) Appl. No.: 14/223,016

(22) Filed: Mar. 24, 2014

(30) Foreign Application Priority Data
Dec. 18, 2013 (MX) MX/A/2013/015148

(51) Int. Cl. B01J 27/051

(52) U.S. Cl. CPC B01J 27/0515

(57) ABSTRACT

The present invention shows a synthesis method for a highly dispersed supported catalyst over a KIT-6 type nanostructured mesoporous oxide with elements from Groups IIIA or IVA, or IVB. The method includes the synthesis of the support, the incorporation of CoMo and NiMo active phases through impregnation to pore volume, assisted by ultrasound, calcination at controlled conditions in order to obtain a phase of hydrated trioxide molybdenum or molybdic acid, which facilitates the subsequent sulfihydration and the mechanical mixing of a CoMoS/support with a hydrodenitrogenant NiMoS/support additive. The obtained catalysts exhibit a catalytic activity mainly in reactions of hydrotreatment, hydrodesulfurization, and hydrodenitrogenation.

### OBJECT OF THE INVENTION

The present invention describes a simple method for obtaining catalysts based on the mechanical mixture of CoMoS sulfides and a NiMoS hydrodenitrogenant additive, both independently supported on three-dimensional nanostructured mesoporous materials. The obtained catalysts exhibit a high catalytic activity in hydrotreatment reactions, mainly in hydrodesulphurization, hidrodenitrogenation, and hydrogenation. Specifically, the aforementioned catalysts are designed for application in deep diesel and gasoline hydrodesulfurization with the objective of achieving levels of total sulphur below 10 ppm. The synthesis method described in this invention uses a porous volume impregnation stage, assisted by ultrasound, as well as an activation stage with a heating cycle and a controlled atmosphere, which makes this method a simple option, economical, and with low environmental impact.

The impact of the present invention lies on the fact that it includes several innovative elements such as the use of a three-dimensional nanostructured mesoporous KIT-6 type support, as well as the development of the impregnation method, and activation of the phase of CoMoS and NiMoS over the nanostructured support with the capacity of generating an active phase with a high dispersion level that generates type II active sites and a crystaline structure favorable for its application in deep hydrodesulfurization processes. The ideal balance in the physical or mechanical mixture between the content of the CoMoS/support and NiMoS/support phases which allows to obtain a catalyst with high resistance to poisoning in the presence of nitrogen compounds in diesel, maintaining its performance over the operation periods required in industrial hydrotreatment processes, in addition that it represents a simple method of achieving a bifunctional catalyst.

The impact of the present invention, for its commercial context, lies on the simplicity of the synthesis method, which will have an impact on the catalyst cost, as well as an impact reduction to the environment beginning from the synthesis, and mainly by presenting a catalytic activity that is superior to the commercially available supported catalysts and that is equivalent to the catalytic activity exhibited by mass catalysts widely used today.

### BACKGROUND

Today the world confronts a global problem of increasing energy demands and, therefore, a daily increase in environmental pollution due to our dependence on the use of petroleum and its derivatives. This has led to the decline of the world's reserves of light oil, resulting in an increased production and availability of heavy oils with a high content of pollutants such as sulphur, nitrogen, asphaltene, carbon and metals such as nickel and vanadium, among those most represented. Due to this fact, and the growing consumption of fuels like gasoline and diesel, environmental standards regarding the quality of these fuels are becoming more stringent. In Mexico, the regulation currently enforced is NOM-086-SEMARNAT, which proposes a maximum Sulphur content of 30 ppm for premium gasoline and 15 ppm for diesel. In order to comply with these standards, the challenges facing the suppliers of catalysts are mainly the increase in the catalytic activity in hydrotreatments (HT) required to meet the specific market demands for ultra-low sulphur content fuels.

Evidently, in general, the world requires more energy for its development. Fuels for transport are among these needs and because the oil industry is the source of these needs, this industry has focused on the improvement of its products, undertaking various actions such as: gasoline oxygenation, sulphur content reduction in gasoline and diesel based on catalytic hydrotreatments, the introduction of new fuels with lower contents of lead and sulphur, such as the case of Magna-Sin gasoline, or the current Premium UBA, and the use of natural gas.

The increased demand of higher quality fuels, together with the great environmental problems, has generated that the catalysts used in refineries face great challenges; the great technological and environmental problems that are generated by having sulphur present in the combustion of hydrocarbons has promoted that the sulphur content in fuels like gasoline and diesel must be drastically reduced to 10 ppm in developed countries such as the United States and European countries (Angelici R. J. 1997. An overview of modeling studies in HDS, HDN HDO and catalysis. Polyhedron, 16, pp. (3073-3088), (Grange P., Vanhaeren X., 1997. Hydrotreating catalysts, an old story with new challenges. Catalysis Today, 36, pp. (375-391), (Guczi L., 1997. Global overview of Catalysis Hungary. Applied Catalysis A: General, 156, pp. (151-160), (Shafi R., Hutchings G. J., 2000.) Hydrodesulfurization of hindered dibenzothiophenes: an overview. Catalysis Today, 59, pp. (423-442), (Breysse M., Djega-Mariadassou G., Pessayre S., Geantet C., Vrinat M., Perot G., Lemaire m, 2003.) Deep desulfurization: reactions, catalysts and technological challenges. Catalysis Today, 84, pp. (129-138), (M. Breysse, Geantet C., P. Afanasyev, Blanchard J., Vrinat M., 2008. Recent studies on the preparation, activation and design of active phases and support of hydrotreating catalysts. Catalysis Today, 130, pp. (3-13), (Ch Song, 2003. An overview of new approaches to deep desulfurization for ultra clean gasoline, diesel fuel and jet fuel. Catalysis Today, 86, pp. (211-263), (Ito E., Rob van Veen j. a., 2006. On novel processes for removing sulphur from refinery streams. Catalysis Today, 116, pp. (446-460), (Oyama S. T., T. Gott, Zhao H., Lee Y-K., 2009). Transition metal phosphide hydroprocessing catalysts: A review. Catalysis Today, 143, pp. (94-107), (Stanislaus a. A., Marafi, Rana M. S., 2010. Recent advances in the science and technology of ultra-low sulfur diesel (ULSD) production. (Catalysis Today, 153, pp. 1-68).

Current legislation on maximum sulphur content allowed in hydrocarbon fuels present a great challenge to the refining industry, where the use of catalysts with optimized properties or new more active and selective catalysts are the great challenge today. Amongst these strategies we find: the use of new active phases such as carbides, nitrides, and phosphides or transition metal sulfides of Mo and W, promoted with Ni or Co. The operation of these phases continues to be explored for practical applications; the development of various sophisticated synthesis method, in which extreme conditions of pressure and temperature are required and the generation of very complex systems that include trimetallic catalysts. Transition metal sulfides (TMS) have been the systems most highly used due to their exceptional resistance to poisoning, as well as their catalytic properties in hydroprocessing reactions, mainly the catalysts formed by MoS₂ or WS₂, which should be stable at conditions of hydrodesulphurization (HDS) commonly at temperatures between 300-400° C. and at a H₂ pressure of 490 psi.

The best catalyst in hydrodesulfurization (HDS) at the end of the past century were Cobalt Sulphide and Molybdenum catalysts supported on alumina, commonly known as CoMo/Alumina; however, at the end of the last century, a new generation of commercial catalysts emerged called STARS for its acronym in English (Super Type II Active Reaction Sites) which are CoMo/Alumina and NiMo/Alumina catalysts that are synthesized using a new alumina support base and a special technique of incorporation of the precursor that allows a very large and uniform dispersion of the metals in the support with moderate density; this family of catalysts quickly overtook the traditional CoMo/Alumina catalysts due to their ability to remove sulphur, especially in esoterically disabled molecules (Song Ch, 2003. An overview of new approaches to deep desulfurization for ultra clean gasoline, diesel fuel and jet fuel. Catalysis Today, 86, pp. 211-263). Subsequent to this major breakthrough in the technology of catalysts synthesis, at the beginning of this decade, a development similar to that attained by STARS catalysts was obtained, thanks to the new catalyst called NEBULA (New Mass Activity) which is a NiWMo mass catalyst, without the use of a support, which enables a high performance in the quality of the products such as low sulphur content, high cetane, low density, etc. It has been reported that it presents a great activity (up to three times that of any other catalytic system, k_{NEBULA}≈31.2×10⁻⁷ mol g⁻¹ s⁻¹, evaluated in a reactor batch at 350° C. and 490 psi) and high stability in HDS, etc. (Song Ch, 2003). An overview of new approaches to deep desulfurization for ultra clean gasoline, diesel fuel and jet fuel. Catalysis Today, 86, pp. (211-263), (Meijburg G., 2001. Production of Ultra-low-sulfur Diesel in Hydrocracking with the Latest and Future Generation Catalysts. Catalyst Courier, 46, Akzo Nobel). Even when the technological contribution of these materials is obvious, it is important to highlight that its use significantly raises the production costs for obtaining clean fuels, so their use is limited to certain levels of beds or layers of the catalytic bed, in which the mission is to treat flows with high content of nitrogen compounds, the following layers of the beds are filled with more economical materials, usually supported, allowing an overall result that allows complying with regulations.

In recent years, there has been a substantial increase in basic research in hydrotreatments (HDT) in aspects such as: the texture of the catalyst, new supports, modifiers, new active phases and the existence of different active sites (Delmon, Catalysis Letters, 22, 1, 1993). Despite the great advances obtained in the modifications to conventional catalysts, these are not active and selective enough to face future demands imposed on fuels in terms of aromatics and sulphur contents. In order to meet future requirements, a new generation of catalysts is needed which must exhibit greater activity, greater selectivity towards the desired products and greater resistance to poisoning, this last requirement due to the deterioration in the quality of the crude that feeds the oil industry. Among the possibilities considered to achieve catalysts with increased selectivity and sensitivity to HDT reactions, we find the modification or change in the support. The modification or replacement of the alumina support has different objectives such as: improving the dispersion of the active phase, modifying the reducibility of the oxide precursor, increasing the useful content of Co(Ni) of the catalyst and reducing deactivation by the formation of coke. Amongst other supports, we find carbon, supports based on titanium and zirconium oxides, silica-alumina, zeolites and clays. F. Luck, Bull. Soc. CHIM. Belg., 100, 781, 1991, presents a collection of such supports, their uses and their benefits.

The nature of the catalyst support plays an important role, therefore, the use of various supports is one of the most important alternatives, such as the work published by K. Soni, B. S. Rana, A. K. Sinha, A. Bhaumik, M. Nandi, M. Kumar, G. M. Dhar, “3-D ordered mesoporous KIT-6 support for effective hydrodesulfurization catalysts”, Applied Catalysis B: Environmental 90 (2009) 55-63, in order to elevate the catalytic activity of the catalyst for HDS. It is well known that the support plays a very important role in the structure that is obtained and in the activity of supported catalysts [T. Chiranjeevi, Rana M. S., Prashant Kumar, G. Murali Dhar, T. S. R. Prasada Rao, j. of Molecular Catalist: Chemical 181 (2002) 109-117, {H. Topsoe, B. S. Clausen, F. E. Massoth, in: J. R. Anderson, M. Boudart (Eds.)}] Hydrotreating Cat. [Science and Technology, Vol. 11, Springer, New York, 1996), D. D. Whitehurst, T. (soda, I. Mochida, Advisor. Catal. 42 (1998) 345), (G. Murali Dhar, M. S. Rana, S. K. Maity, T. S. R. Prasada Rao, B. N. Srinivas, in: C. Song, S. Hsu, I. Mochida (eds.), Chemistry of Diesel Fuels, Taylor & Francis, London, 2000 (Chapter 8)].

In addition to γ-Al₂O₃ as a support, there are other alternatives that have been studied, among which we can mention mainly clays (K. A. Carrado, J. H. Kim, C. S. Song, N. Castagnola, C. L. Marshall, M. M. Schwartz, Catalysis Today 116 (2006) 478-484), carbon {R. Prins, V. J. H. of Beer, G. A. Somsserjai, Catal. Rev. Sci. Eng. 31 (1989)}, oxides (L. C. Caero, A. R. Romero, J. Ramirez, Catal. Today 78 (1-4) (2003) 513, M. C. Barrera, M. Viniegra, J. Escobar, M. Vrinat, J. A. de los Reyes, F. Murrieta, J. García, Catal. Today 98 (1-2) (2004) 131), (S. K. Maity, M. S. Frog, B. N. Srinivas, S. K. Bej, G. Murali Dhar, T. S. R. Prasada Rao, J. Mol.) Catal. A: Chem. 153 (1-2) (2000) 121), (G. Murali Dhar, F. E. Massoth, J. Shabtai, J. Catal.) (85 (1994) 44), mixed oxides (S. Damyanova, L. Petrov, M. A. rye, P. Grange, Appl. Catal. (A: Gen. 224 (1-2) (2002) 271), (M. S. Frog, E. M. R. Capitaine, C. Leyva, J. Ancheyta, 86 Fuel (9) (2007) 1254), (M. S. Frog, J. Ancheyta, S. K. Maity, G. Murali Dhar, T. S. R. PrasadaRao, Appl.) Catal. (A: Gen. 268 (1-2) (2004) 89), (F. E. Massoth, G. MuraliDhar, J. Shabtai, J. Catal. 85 (1994) 52, F. P. Daly, H. Ando, J. L. Schmitt, E. A. Sturm, J. Catal.)(108 (1987) 401), (M. S. Frog, B. N. Srinivas, S. K. Maity, G. Murali Dhar, T. S. R. Prasada Rao, J. Catal.) (195 (2000) 31), (W. Zhaobin, X. Qin, G. Xiexian, E. L. Sham, P. Grange, B. Delmon, Appl.) Catal.(75 (1991) 179), zeolites (D. Li, A. Nishijima, D. E. Morris, j. Catal. 182 (2) (1999) (339), W. J. J. Welterweights, G. Vorbeck, H. W. Zandbergen, J. M. van de Ven, E. M. van Oers, J. W. de Haan, V. H. J. of Beer, R. A. van Santen, J. Catal. 161 (2) (1996) 819), mesoporous type MCM-41 materials (A. Wang, Y. Wang, T. Kabe, Y. Chen, A. Ishihava, W. Qian, P. Yao, J. Catal. 210 (2002) 319, T. Klimova, M. Calderon, J. Ramirez, Appl.) Catal. A: Gen. 240 (2003) 29), (A. Wang, y. Wang, T. Kabe, y. Chen, A. Ishihara, w Qian, J. Catal.) (199 (2001) 19), (U. T. Turaga, C. Song, Catal. Today 86 (2003) 129), HMS (T. Chiranjeevi, Rana M. S., P. Kumar, G. Murali Dhar, T. S. R. Prasada Rao, J. Mol.) Catal. A: Chem. 181 (2002) 109) and SBA-15 (G. Murali Dhar, G. Muthu Kumarana Manoj Kumara K. S. Rawat, L. D., B. David Raju, K. S. Rama Rao, Catal.) (Today 99 (2005) 309), (R. Palcheva, A. Spojakina, L. Dimitrov, K. Jiratova, Microporous and Mesoporous Materials 122 (2009) 128-134).

In recent years, great interest has developed on mesoporous supports based on silicon oxide due to the many structures in which it can be obtained. Mesoporous materials with ordered structures have received much attention because of their potential for application in catalysts (A. Corma, Chem. Rev. 97 (1997) 2373-2420). Silicon based mesoporous materials such as MCM-41, MCM-48, SBA-15, SBA-1 and KIT-6 are obtained by methods of self-assembly with ionic and anionics long chain tensoactive agents used as pattern and different precursors or silicon sources (F. Kleitz, S. H. Choi, R. Ryoo, Chem. Commun. (2003) 2136-2137). The porous structure, i.e., the shape of the pores and the connectivity between them, is determined by the chosen surfactant and the conditions of synthesis (R. Ryoo, C. H. Ko, M. Kruk, V. Antochshuk, M. Jaroniec, J. Phys. Chem. B 104 (2000) 11465-11471). Under this context, the architecture of the pores is decisive since it defines the degree of applicability of the different silica based supports.

Silicon based mesoporous support, known as KIT-6, exhibits a three-dimensional cubic structure with a la3d symmetry, which also has a network of canals that are interconnected in a “bicontinuos” way (T. W. Kim, F. Kleitz, B. Paul, R. Ryoo, J. Am. Chem. Soc. 127 (2005) 7601-7610). This provides highly open spaces to allow direct access to the species without blockage of the pores, due to its unique network of canals in three dimensions. KIT-6, apart from offering large pores, presents pore walls of large thickness, high hydrothermal stability, high specific surface area, and high pore volume. Therefore, it is expected that these materials are superior to the rest of the mesoporous structures, allowing a greater dispersion of the active phase and faster access of the reagents and products during the reaction in the mesopores interconnected three-dimensionally.

Currently, there are some patents which describe methods for obtaining supported catalysts, similar to that described in this patent. In the description of these patents it is evident that they employ the traditional alumina based support, in some cases mixed oxides or zeolites, which are known for textural limitations in terms of low specific surface area and relatively small pore diameters for hydrodesulphurization applications. These characteristics inhibit a high dispersion of the active phase and therefore generate sulphur phases with a high stacking level and type I structures. Some of the catalysts described in these patents have a high metal content of the catalysts (up to 60% by weight, with the consequent high cost) and some have chemical mixtures of multiple metals, which limit the homogeneity of the active phase and complicates the reproducibility of methods for their obtention, especially when it is scaled to industrial level. The patents are the following:

In U.S. Pat. No. 7,615,509 B2 discloses a method for preparation and application of supported catalysts, ranging from a simple cobalt-molibdeno system with a metal load of up to 60% by weight of alumina (gamma, theta, delta, kappa, eta, or mixtures) doped with silica or halogens. It also describes trimetallic catalysts (Mo or W—Co, or Ni—Zn) with a load of up to 50% in weight on such support or a much more complex system which refers to other transition metals such as ruthenium, rhenium, rhodium, iridium, among others. The support used presents a very low pore volume (0.4 cc/cc), which prevents obtaining a high dispersion of the metals at loads up to 60% by weight. The preparation method has several disadvantages as a support, that even though it is stable, offers very low textural properties needed to disperse a high load of metals and therefore obtain a type I active phase, which is evident in the relatively low catalytic activity of only 0.4 times higher than the CoMo catalyst, besides the high metal load which results in a higher cost.

U.S. Pat. No. 5,130,285 presents a method for the preparation of catalysts for use in the hydrodesulfurization and hidrodenitrogenacion of fuels based on CoMo supported on a mixed oxide TiO₂—ZrO₂—V₂O₅. The support synthesis is achieved by co-precipitation of the precursors with an aqueous solution of ammonium in an alcoholic medium; the product is dried and calcinated. The support has surface area values ranging from 53 to 208 m²/gr, pore volume in the order of 0.3 cc/g. The addition of the active phase is through successive impregnations with a solution of ammonium heptamolybdate and cobalt nitrate, which is subsequently dried and calcinated. A gamma-alumina based material is comparatively prepared. The catalyst obtained, in some cases, barely obtains a 0.19 improvement over the commercially available catalyst tested in the same patent.

On the other hand, U.S. Pat. No. 5,981,821 discloses an impregnation method based on a stage of supports in an aqueous solution for the production of the catalysts, as well as its application in hydrotreatments. The solution is a mixture of metals from group IVa (e.g. Zr), at least one metal component of Group VIa (e.g. Mo or W), at least one metal component of the Group VIII (e.g. Co or Ni) and at least one water soluble Amine (ethylenediamine, MEA). An example of the formulation includes 8.1 g of ammonium heptamolybdate, 11.5 cm³ of water, 5.6 cm³ of MEA, 5.4 g of cobalt nitrate, 2.55 g of a liquid containing Zr (marketed as Bacote 20 by Magnesium Electron Ltd). All these components in solution are added to a commercial alumina containing 4% by weight of silica, with a pore volume of 1 cm³/gr for a final load of metals of approximately 30% in weight. Maximum catalytic conversion obtained by these catalysts is 86%; therefore, and considering that we depart from a gasoleum of 11,430 ppm of sulfur, 1,600 ppm of sulphur are left remaining that is above the commercial catalyst (500 ppm).

United States Patent Application Publication No. 2009/0223867 A1 discloses a process for selective hydro-desulfurization of a hydrocarbon feeder containing olefins with a low surface area catalyst (less than 100 m²/g) and an average pore diameter of 200 Å, whose composition contains cobalt, molybdenum, phosphorus, and alumina as a support (theta and delta). The final catalyst composition is approximately 30% of load and a surface area value of 98 m²/gr. The catalytic activity is 0.4 times greater than the referenced one. In the same way that in the patents before mentioned, low textural properties prevent a better dispersion of the active phase and therefore generate a not-so-active phase, even while they have a relatively high load (30% in weight).

U.S. Pat. No. 7,556,729 B2, by the same inventors, describes a method of selective hydrodesulfurization of olefins using a catalyst with a high content of nickel and small amounts of molybdenum supported on a porous refractory oxide. The catalyst contains preferentially incorporated a quantity of cobalt. The support is alumina based, modified with nickel and extruded with approximately 25% by weight of metals. The support has a surface area between 100-400 m²/g; however, the percentage of sulphur removed is between 40 and 78%, which would not comply with the standards set today.

In the same way, United States Patent Application Publication No. 2006/0054536 A1 discloses a catalyst for gasoleum hydrotreatment, as well as the method of obtaining it. This patent claims that the catalyst is able to achieve ultra-low contents of sulphur through hydrodesulphurization, without severe conditions and at the same time, to obtain hydrodenitrogenation. The catalyst discussed contains an inorganic oxide as the support with between 10-40% in weight of metal, this means a high content of metals, 1-15% in weight of metal from Group 8 of the periodic table, 1.5-8% by weight of phosphorus, and 2-14% by weight of carbon. The surface area of the catalyst is between 150-300 m²/g and the pore volume between 0.3-0.6 ml/g. An example of the formulation is 22.3 g of zeolite SHY (Radio molar SiO₂/Al₂O₃=6), 10.27 g of cobalt citrate is added, 2.24 g of phosphoric acid, and subsequently 17.61 g of acid molybdofosforic acid, impregnation is carried out by immersion of the support in the precursors solution of the active phase. In some cases, citric acid and nickel citrate are included. According to the picture presented in the patent, the dispersion of the crystals in active phase is not so high, although they report pilings between 2 and 4, mainly close to 4 and sulphur remnant results of 180-8 ppm, without a correlation between the piling and the catalytic activity, as is typically expected. The method's disadvantages are that it can generate multiple phases and therefore not be homogeneous and reproducible, especially when it is trimetalic; also, it starts from expensive precursors, it does not take total advantage of the surface area and presents relatively high loads of metals (40% by weight).

U.S. Pat. No. 5,248,412, discloses a catalysts preparation method for hydrocarbons hydrodesulphurization and the hydrodesulphurization process per se. The catalyst is supported on alumina or on materials containing impregnated alumina with at least one alkoxide, a chelating compound, or a glicoxide of molybdenum or chrome. Besides, at least one alkoxide, a chelating compound or cobalt or nickel glicoxide, and an organic solvent capable of dissolving such components in order to obtain a CoO—MoO₃ catalyst over Al₂O₃ with 20% by weight of metal; however, the minimum remaining contents of sulfur after hydrotreating is 900 ppm, which is not regarded as ultra-low sulfur.

U.S. Pat. No. 6,231,754 B1 discloses a gasoline hydrodesulphurization process at high temperatures using a new catalyst of low metallic loading (2-40% in weight) and a partially deactivated catalyst. Favorite catalytic metals include Co and Mo in an atom ratio of 0.1 to 1. The catalyst is preferably at least partially regenerable, has less than 500 ppm by weight of a total of one or more of elements such as nickel, iron, and vanadium and has no more than 15-25% by weight of catalytic metals calculated as oxides. The spent lot is a commercial, low load and highly dispersed catalyst consisting of 4.34% of MoO₃ and 1.19% in weight of CoO on alumina, which has a degree of hydrodesulfurization between 89-93.4%. In the same way, new catalyst is prepared with 6.5% by weight of MoO₃ and 2.2% by weight of CoO over alumina, which reaches 90% of hydrodesulfurization. The patent also shows the use of the mixture of used and new catalyst (2-40% in weight) reaching a maximum percentage of hydrodesulfurization of 79%; therefore, although it is a good result, it does not reach levels below 30 ppm of sulphur that are set in the regulation.

In the same way, United States Patent Application Publication No. 2003/0183556 A1 discloses a process for the selective hydrodesulphurization of naphtha with the preferred use of a catalyst containing between 1-10% by weight of MoO₃ and from 0.1 to 5% by weight of CoO. U.S. Pat. Nos. 6,589,418; 6,126,814 and 6,013,198 disclose a process for the selective hydrodesulfurization of a naphtha feeder containing olefin with catalysts similar to those described in the United States Patent Application Publication No. 2003/0183556.

### BRIEF DESCRIPTION OF THE FIGURES

FIG. 1 shows a general flowchart of the process of synthesis and preparation of the CoMoS₂/NiMoS₂ catalyst proposed in this invention;

FIG. 2 shows a micrograph obtained by a high resolution, transmission electron microscope (HR-TEM) of the nanostructured KIT-6 type mesoporous silica used as support of the active phase of the catalyst of the present invention;

FIG. 3 shows a micrograph obtained by a field emission, scanning electron microscope FE-SEM of the nanostructured KIT-6 type mesoporous silica used as support of the active phase of the catalyst of the present invention;

FIG. 4 shows a thermogram of the heptamolybdate of ammonia salt used as a precursor of molybdenum in oxide based catalysts;

FIG. 5 shows a micrograph obtained by a high resolution, transmission electron microscope (HR-TEM) of the support, zone “A”, impregnated with precursor oxides of active phase, zone “B”;

FIG. 6 shows a graph showing the specific surface area as a function of the Ti content in KIT-6 type supports;

FIG. 7 shows a graph showing the constant rate of reaction in hydrodesulphurization (HDS) of dibenzothiophene (DBT) in a batch reactor at 350° C., 490 psi of hydrogen, as a function of titanium (Ti) in KIT-6 type supports. The reaction rate constant of an unsupported commercial catalyst and that of a supported catalyst used as reference are 31.2×10⁻⁷ mol g⁻¹ s⁻¹ and 6.6×10⁻⁷ mol g⁻¹ s⁻¹, respectively;

FIG. 8 shows a comparative graph of the content of sulphur compounds in feeder primary light gasoleum (LPG) (1) and the end product after HDS with the catalysts of reference (2), in a continuous piston flow reactor (PFR) with 16,000 ppm of total initial sulphur, operated at 660 PSI, 350° C. and LHSV=1.0 h⁻¹;

FIG. 9 shows a comparative graphic of the content of sulfur compounds in feeder GLP (1) and the end product after HDS with CoMoS/KIT-6 type support and NiMoS/KIT-6 type support (3) in a PFR reactor with 16,000 ppm of total initial sulphur, operated at 660 psi, 350° C. and LHSV=1.0 h⁻¹;

FIG. 10 shows a graph showing the performance of the reference catalyst in HDS in a PFR system, expressed as total sulphur concentration (ppm) in the reaction effluent and % conversion. The reaction conditions are: GLP load with 16,000 ppm of total sulphur, 660 psi and 350° C., LHSV=1.0 h⁻¹. The arrows indicate the reading scale of each curve;

FIG. 11 shows a graph showing the performance of the CoMoS/KIT-6 type support/NiMoS/KIT-6 type support catalyst in HDS in a PFR system, expressed as total sulphur concentration (ppm) in the reaction effluent and % conversion. The reaction conditions are: GLP load with 16,000 ppm of total sulphur, 660 psi and 350° C. and LHSV=1.0 h⁻¹. The arrows indicate the reading scale of each curve;

FIG. 12 shows a graph showing the dependence of sulphur concentration as a function of temperature, pressure and space velocity of the CoMoS/KIT-6 type support/NiMoS/KIT-6 type support;

FIG. 13 shows a micrograph obtained by a HR-TEM of the CoS₂—SiO₂/NiS₂—SiO₂ catalyst supported over a KIT-6 type nanostructured mesoporous silica; the active phase nanocrystal is shown in box “c”; and

FIG. 14 shows a histogram showing the distribution of the piling number of the CoS₂—SiO₂/NiS₂—SiO₂ catalyst supported over a KIT-6 type nanostructured mesoporous silica

### DETAILED DESCRIPTION OF THE INVENTION

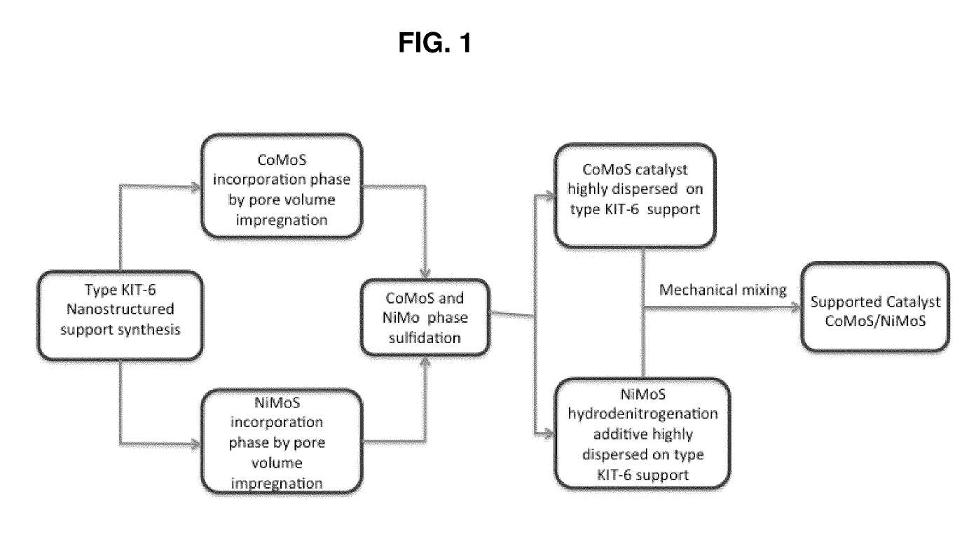

The present invention describes a method for obtaining catalysts based on the mechanical mixture of CoMoS₂ and NiMoS₂ sulfides for deep hydrodesulphurization of diesel and gasoline, based on the physical or mechanical mixture of a system including cobalt, molybdenum and sulphur (CoMoS) and an hydrodenitrogenant additive composed of nickel, molybdenum and sulphur (NiMoS) supported independently on a nanostructured mesoporous known as KIT-6 type support, which can be of Al₂O₃, SiO₂, ZrO₂, TiO₂, and their mixtures, preferably base SiO₂ nanostructured mesoporous in three dimensions. The scheme of synthesis and preparation is described in a general way in the flowchart shown in FIG. 1. In a first stage, the synthesis of the KIT-6 type nanostructured support is synthesized by means of the Sol-Gel technique of emulsions of an organic precursor of self-assembled silicon with a nonionic triblock surfactant and a liposoluble structured orientor compatible with the surfactant. The method is detailed below.

The nonionic triblock surfactant poly (ethylene glycol)-b-poly(propylene glycol)-b-poly (ethylene glycol) (Pluronic 123 by its commercial name) is dissolved in distilled water and concentrated HCl (35% by weight, density 1.18 g/cc) at 35° C. until complete dilution of the surfactant. 19-30 ml of n-butanol is added to the emulsion and it is subjected to agitation for 1 hour at 35° C. in a closed system in order to prevent the loss of butanol by evaporation.

Subsequently, 36.6 mL of the silicon organic precursor, sodium silicate, or tetraethyl orthosilicate, preferably of tetraethyl orthosilicate (TEOS, 98% by weight) is added by dripping at 35° C. The mixture is agitated during 24 h, between 30-60° C., to assist the process of polycondensation of the dioxide of silicon over the self-assembled micelle of n-Butanol-Pluronic. The resulting suspension is placed in an autoclave, which undergoes hydrotreating for 24 hours between 100-140° C., preferably 120° C. As a result, a solid precipitate is produced in the bottom of the autoclave which includes a support impregnated with the surfactant which is preferably filtered and dried at 100° C. for 12 hours. After drying, the solids are washed with a solution of hydrochloric acid in ethanol with relations in volume of 0.00162-0.1465, preferably 0.1465, during a time of between 10 to 30 minutes. The washed solids are filtered in a vacuum and then subjected to a process of calcination for 1 to 24 hours at 550° C. in order to remove the organic phase of the surfactant remnants and to generate the KIT-6 type nanostructured mesoporous silica dioxide support used in the present invention. The support obtained is superficially modified with different elements of group IIIA such as boron (B) and aluminium (Al) or from Group IV B such as titanium (Ti) and zirconium (Zr) or from Group VA such as phosphorus (P) or antimony (Sb), preferably Ti in atomic ratios of 2.5 to 15.

### Example 1

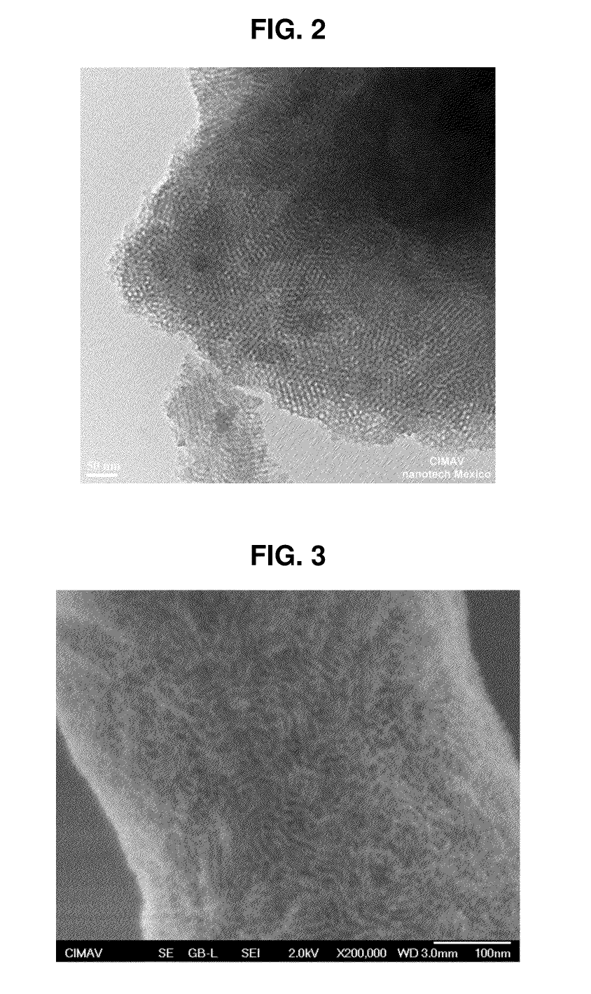

FIG. 2 shows a micrograph of the support obtained by a high-resolution, transmission electron microscope (HR-TEM)

### Example 2

FIG. 3 shows a micrograph of the support obtained by a field emission, scanning electron microscope (FE-SEM).

### Example 3

Table 1 shows the textural properties determined by nitrogen physisorption analysis B.E.T.

TABLE 1
Summary of textural properties of KIT-6 type nanostructured
mesoporous support obtained by nitrogen physisorption analysis

| Textural property | Range of values | Units |
|---|---|---|
| Surface area | 700-800 | m²/g |
| Pore diameter | 9-12 | nm |
| Total pore volume | 1.10 1.4 | cm³/g |

The second stage of the flowchart in FIG. 1, shows the incorporation of the CoMo and NiMo phase separately over the KIT-6 type support, using both organic and inorganic precursors of Ni, Co and Mo. The precursor compounds of nickel can be oxisalts, sulfates, halides (Cl⁻¹, F⁻¹, I⁻¹, Br⁻¹, S⁻¹), and nitrates, preferably nitrates. Within the organic precursors of nickel, we can find salts of carboxylic acids of C₂-C₁₆. The precursor cobalt compounds can be oxisales, sulfates, halides (Cl⁻¹, F⁻¹, I⁻¹, Br⁻¹, S⁻¹), and nitrates, preferably nitrates. As organic cobalt precursors we can find salts of carboxylic acids C₂-C₁₆ or sulfonates C₂-C₁₆. Finally, as precursors of molybdenum, we can use oxisalts and tiosalts of molybdenum, such as the tiomolybdate (TMA) and heptamolybdate (AMF) of ammonium, preferably heptamolybdate of ammonium.

Functionally, cobalt and nickel in the precursor phase of the active phase are used as promoters of catalytic activity and will be listed as such in the following description. As shown in FIG. 1, the incorporation of the CoMo and NiMo phases over the support was performed separately according to the following procedure. For the incorporation of the CoMo phase, first we incorporated 0.1 to 0.2 g of the cobalt precursor by impregnation, the precursor which can be any of those previously described, preferably nitrate of cobalt (II), which is dissolved in a volume of distilled water between the total pore volume of the support and the double of the total pore volume of the support. Once the cobalt precursor is dissolved in the aqueous phase, this solution is used to impregnate the support with the assistance of ultrasound, for a period between 3 and 20 minutes. The paste produced by impregnating is dried at 80° C. for a period of 30 minutes. In parallel, under this same procedure, a solution with the precursor of molybdenum, which can be an oxisal of molybdenum preferably hydrated ammonium heptamolybdate, is prepared using a volume of distilled water equal to the total pore volume of the support. After drying the support that has been pre-impregnated with the cobalt precursor, the molybdenum precursor solution is incorporated using ultrasound to produce a paste that is subjected to drying for 30 minutes at 80° C. At this stage of the synthesis, we have obtained a solid powder of support, which is impregnated with the precursors of the CoMo phase with metal loads between 2 and 20% by weight. The same procedure is followed for the NiMo phase over the KIT-6 type nanostructured mesoporous support.

A key aspect in the method of synthesis of the present invention is the calcination of the precursors in order to generate oxides of cobalt and molybdenum, and of nickel and molybdenum with a controlled level of hydration. Formula 1 shows the different concepts for the structure of the hydrated trioxide molybdenum. The hydrated trioxide molybdenum or the molybdic acid described by structure “A” of Formula 1 is an amorphous compound with hydroxyl groups of low chemical stability that can be sulphide with greater success during the process of sulfihydration (activation) according to the reaction described in Formula 2. The hydration water that structure “A” produces has hydroxyl groups that produce fault sites in the crystal structure, where the sulfidation is performed with greater success. Structures “B” and “C” are similar structures with different geometric arrangements, which are reversible amongst themselves and with the structure “A”.

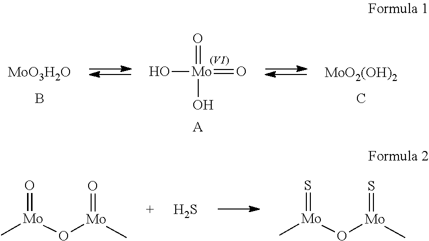

A key point of this development is the formation of molybdic acid from the molybdenum precursor, which facilitates the deep sulphidation of the molybdenum during the subsequent process of sulfihydration (activation).

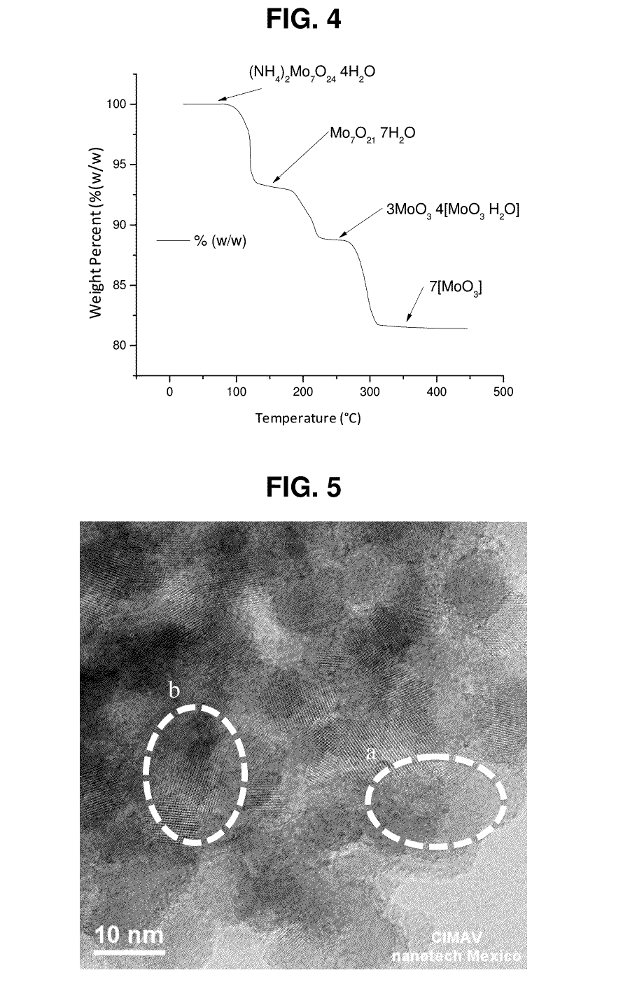

To generate the molybdic acid phase, we perform a calcination of the active phase impregnated in the support at 110-250° C. in air atmosphere for a period of 3 hours. This treatment promotes the formation of hydrated molybdenum trioxide or molybdic acid, which is confirmed by the thermogravimetric analysis shown in FIG. 4. The percentages of weight loss correspond to the formation of the proposed structures; therefore, at 150° C. we obtained the form of fully hydrated molybdenum trioxide fully, at 250° C. we obtained a structure partially hydrated, and, above 350° C. we obtained a structure of molybdenum trioxide in its completely anhydrous form.

Under the circumstances described, the CoMo and NiMo precursor material must be calcined at 160° C. for a period of 3 hours. Up to this point, what we obtained were supports impregnated with oxides of NiMo and CoMo (FIG. 5) with a high level of hydration that facilitate the deep sulphidation of these precursors in the subsequent stage of sulfihydration, in the micrograph we show the oxide, “a” in FIG. 5 and the support, “b” in the same FIG. 5.

After obtaining the hydrated molybdenum trioxide in the CoMo and NiMo materials, both materials were subjected to a process of sulfihydration (activation) which takes place in 3 stages. As a first stage, we proceeded to sulphurize in the presence of a H₂S/H₂ atmosphere (10-30% by volume of H₂S) with a flow between 20-60 ml/min, preferably 45 ml/min at room temperature for a period of 3 hours to obtain a composite sulfo-hydroxylated of molybdenum according to the following reaction:

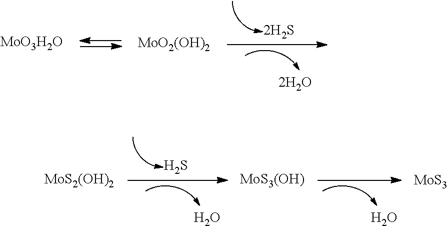

In a second stage, the material is suddenly heated to 300° C. while maintaining the same atmosphere of H₂S/H₂ (15% by volume of H₂S) to achieve the formation of a molybdenum trisulphide as amorphous as possible, which simultaneously produces a highly dispersed phase over the internal and external surface area of the support. Finally, in a third phase, the trisulphide molybdenum, is heated to a temperature between 350-500° C., with a ramp of 2-10° C./min and maintained for a period of 2 hours in an atmosphere of H₂/N₂ (20% by volume of H₂) to generate the structure of disulfide of molybdenum according to following reaction:

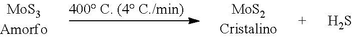

Under these conditions, the stage of molybdenum disulfide formed is crystaline; however, molybdenum trisulphide is an amorphous enough structure, and when this compound is subjected to the third step, a molybdenum disulfide structure occurs with a high degree of faults in its crystaline structure producing a consequent high activity in HDS processes.

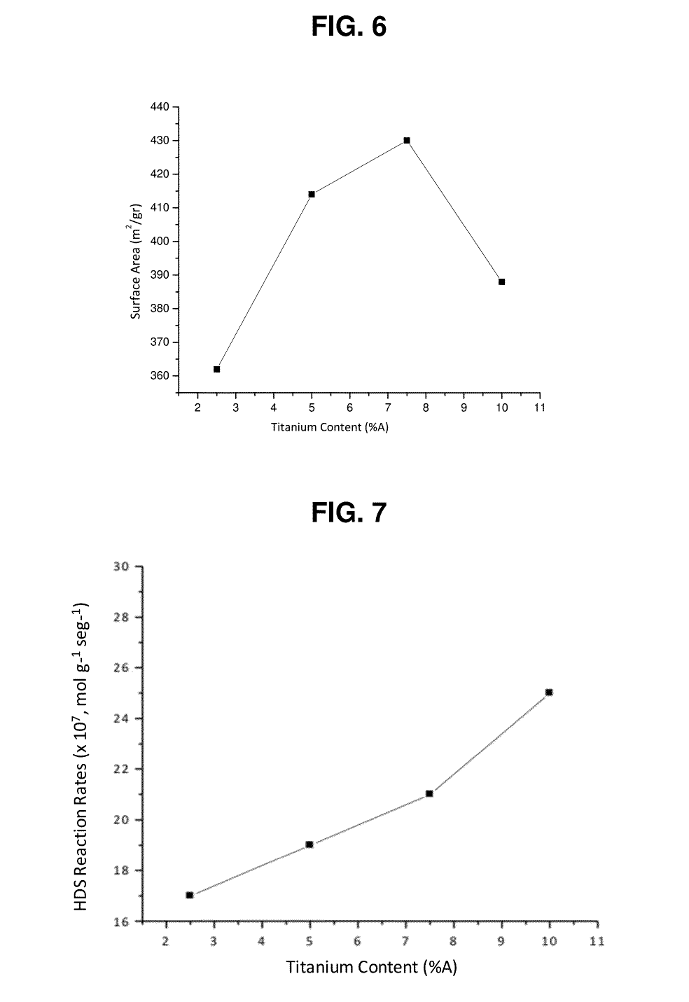

Under the process of sulfihydration previously described, we obtain catalysts with phases of CoMoS and NiMoS supported over a nanostructured mesoporous silica, having this powder a mesh size of 150 microns and an intense dark grey color. The materials obtained separately are then mixed mechanically at a ratio of 50 to 90 parts of the CoMoS catalyst, per 10-50 parts of the NiMoS hydrodenitrogenant additive. The product is a catalyst supported over phases of CoMoS and NiMoS with the ability to achieve levels of total sulphur below 10 ppm in a process of hydrodesulfurization of diesel under normal hydrotreatment conditions. The values of surface area of the catalyst as a function of the Ti content in the support is shown in FIG. 6 and they vary between 362 to 430 m²/g, with a pore diameter of 9.3 nm and a pore volume between 0.63 and 0-8 cc/g, with the active phase already incorporated and activated.

### Example 4

The evaluation of the catalysts is conducted both in a batch system and in a continuous flow system. In the batch test, a high pressure reactor was used at 1 Lt to 350° C., 490 psi of hydrogen and dibenzotiofenos as a model molecule, while on the continuous reactor or PFR, the catalysts were evaluated with a GLP containing 1.5% by weight of sulphur, 408 mg/Kg of total nitrogen, 0.8803 density, molecular weight of 285 and bromine number of 2.0 gBr/100 g. The PFR was operated at temperatures between 350 and 370° C., pressure between 650 and 750 psi of hydrogen and a LHSV⁻¹ from 1 up to 2. Reference catalysts were tested under these same conditions. FIGS. 7 through 11 present the results of the catalytic evaluations.

### Example 5

Synthesis method for a 3D nanostructure mesoporous supported catalyst with a 16% CoMo loading:

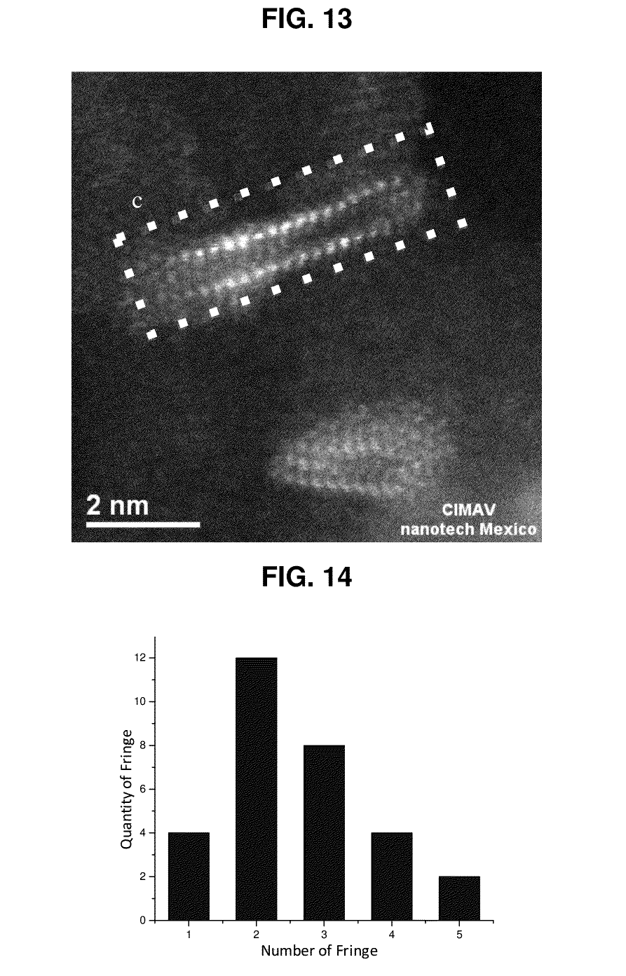

A cobalt precursor solution is prepared with 0.16 g of nitrate cobalt hexahydrate dissolved in 2.5 mL of distilled water in a beaker. Separately, 0.84 g of mesoporous silica is weighed which has been prepared according to the procedure described in the previous section. The mesoporous silica is mixed with cobalt nitrate solution, assisted by ultrasound, for a period of 5 minutes. The paste that is produced is dried in an oven at 80° C. for a period of 10 minutes. At the same time, the molybdenum precursor solution is prepared with 0.24 g of heptamolybdate of amonium tetrahydrate and 2 mL of distilled water. The dried support is impregnated with cobalt nitrate and added to the heptamolybdate ammonium solution, incorporating the solution by mixing assisted by ultrasound for a period of 5 minutes. The paste produced is dried at 80° C. for a period of 10 minutes. The resulting dry solid was subjected to calcination at 160° C. for a period of 3 hours, and then subjected to sulfihydration in a tubular furnace system. The solid material was introduced in the tubular furnace where it was subjected to a process of sulfihydration using a gas stream of 45 mL/min of a mixture of H₂S/N₂ (15% H₂S) for a period of 3 hours at room temperature. Then, under the same gas stream, the material was suddenly subjected to 300° C. and kept at this condition for 3 hours. Subsequently, the sulfihydration atmosphere was changed to a reducing atmosphere using a gaseous current of 45 mL/min of a mixture of H₂/N₂ (20% H₂) and simultaneously heating to 400° C. with a heating rate of 4° C./min, the temperature was maintained for a period of 2 hours. Finally, the oven was cooled to room temperature while maintaining an inert atmosphere with a stream of nitrogen at 30 mL/min. A solid black color material is obtained as a catalyst supported with active phase of CoMoS. The catalyst obtained was characterized in its textural, crystallographic, morphological and catalytic properties to validate the accuracy of the method and the efficiency of the object of this invention claimed in the present patent document. The morphology of the type II catalyst is shown in FIG. 13, with a piling of two layers and a length of 4.1 nm (FIG. 13, box “c”).

### Example 6

Synthesis method for a 3D nanostructure mesoporous supported hydrodenitrogenant additive with a 16% NiMo loading:

A solution of the Ni precursors is prepared with 0.26 g of nickel nitrate hexahydrate and 2.5 mL of distilled water within a beaker. 0.84 g of mesoporous silica is weighed separately, that has been prepared according to the procedure described before. The mesoporous silica is slowly mixed with the nickel nitrate solution, assisted by ultrasound, for a period of 5 minutes. The paste produced is dried in an oven at 80° C. for a period of 10 minutes. At the same time, the molybdenum precursor solution is prepared with 0.24 g of heptamolybdate of tetrahydrate amonium and 2 mL of distilled water. The dry support is impregnated with nickel nitrate and added to the solution of heptamolybdate ammonium, incorporating the solution by mixing, assisted by ultrasound, for a period of 5 minutes. The paste produced is dried at 80° C. for a period of 10 minutes. The resulting dry solid was subjected to calcination at 160° C. for a period of 3 hours; then, it was subjected to sulfihydration in a tubular furnace system. The solid material was introduced in the tubular furnace where it was subjected to a process of sulfihydration using a gas stream of 45 mL/min of a mixture of H₂S/N₂ (15% H₂S) for a period of 3 hours at room temperature. Then, under the same gas stream, the material was suddenly subjected to 300° C. and kept at this condition for 3 hours. Subsequently, the sulfihydration atmosphere was changed to a reducing atmosphere using a gaseous current of 45 mL/min of a mixture of H₂/N₂ (20% H₂) and simultaneously heating to 400° C. with a heating rate of 4° C./min, the temperature was maintained for a period of 2 hours. Finally, the oven was cooled to room temperature while maintaining an inert atmosphere with a stream of nitrogen at 30 mL/min. As a result, we obtain a solid material with an intense black color as a supported catalyst with a NiMoS₂ active phase. This material was characterized under the same techniques described in example 1.

### Example 7

Preparation and performance evaluation of the supported catalyst with phases of CoMoS and a NiMoS hydrodenitrogenant additive:

Catalytic materials prepared in examples 1 and 2 were mechanically mixed with an impeller mixer with a ratio by weight of 75% of the CoMoS base catalyst and 25% of the NiMoS based hydrodehidrogenant additive. The mechanical mixture allows the obtention of the catalyst claimed in the present invention which exhibits high activity and stability in hydrodesulfurization processes, obtaining yields that allow reaching levels of ultra-low sulfur.

The mentioned material was subjected to HDS evaluation using as a feeder a light primary gasoleum (GLP) with 15,000 ppm of total sulphur content, in a continuous regime system of a piston flow type in a packaged bed according to the following procedure and conditions.

For evaluation with DBT as a model compound, a sample of approximately 2 g of catalyst was weighed and placed on a cell of perforated stainless steel, preparing the packaged bed for the HDS reaction. The GLP used during the evaluation was fed to the PFR reactor during the hydrodesulfurization reaction conditions summarized in Table 2.

TABLE 2
Operation conditions of the continuous
regime reactor during the pilot evaluation.

| CONDITIONS | VALUES |
|---|---|
| Operating temperature | 350-370° C. |
| Hydrogen pressure | 45-60 kg/cm² |
| Liquid hourly space velocity (LHSV) | 1-2 |
| Hydrogen/liquid flow ratio | 160 mL H₂/mL liquid |

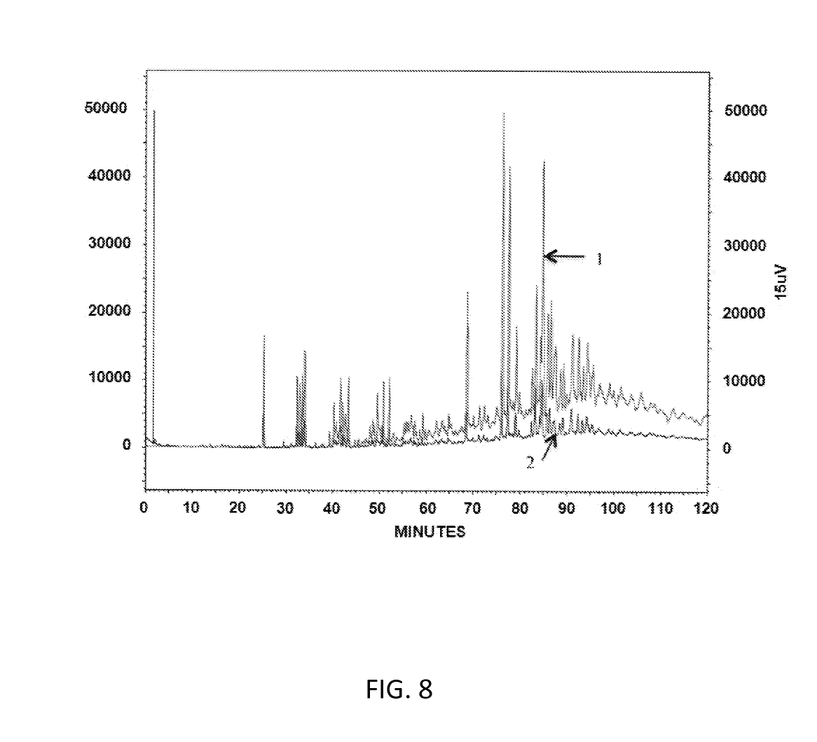

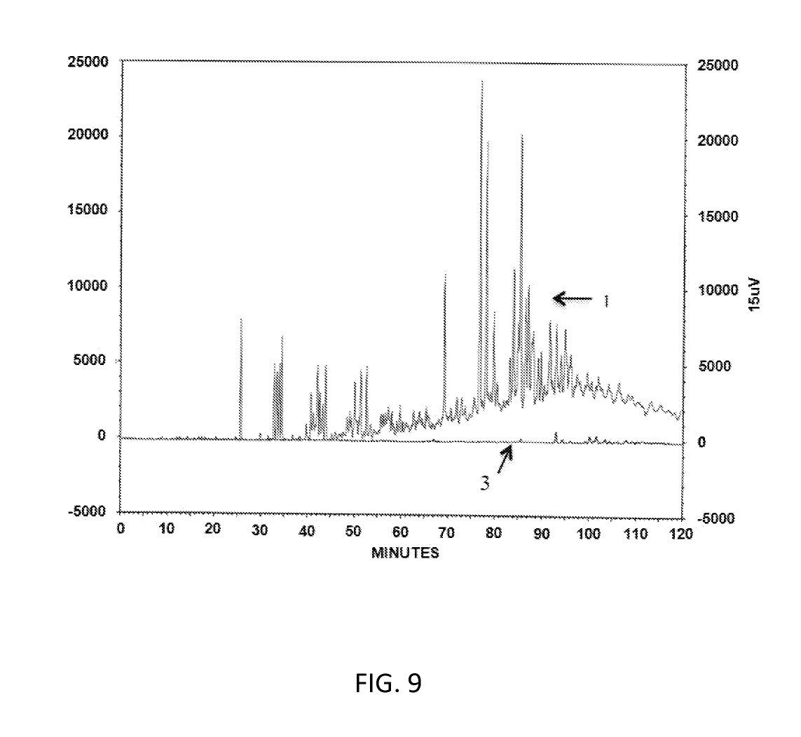

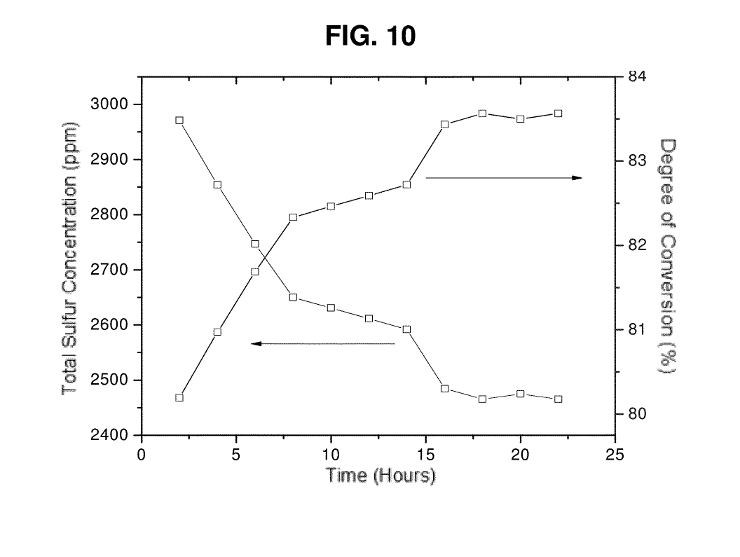

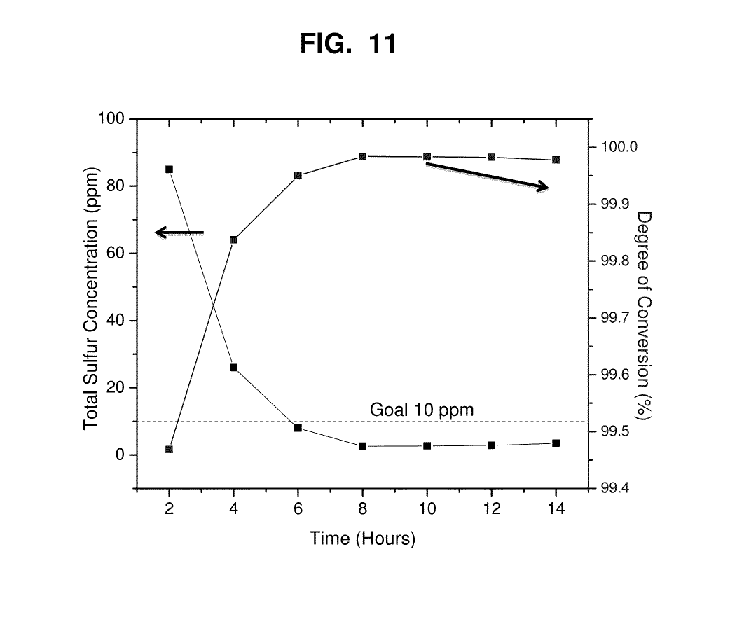

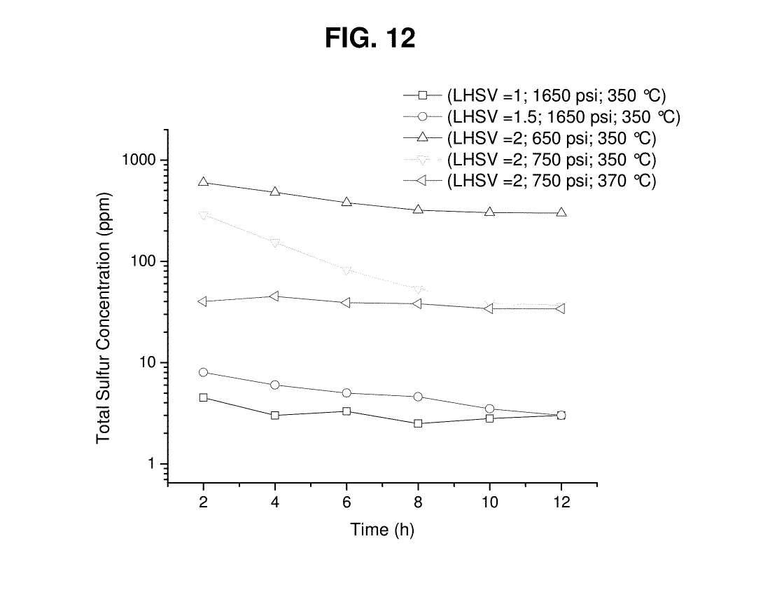

The GLP effluent pumped from the reactor was evaluated in a gas chromatograph with a sulphur compounds detector based on sulphur chemiluminiscence (GC-SCD) in order to evaluate the performance of the catalyst in the reduction of the content of total sulphur in the GLP. The results of this assessment are shown in FIGS. 8-12. As shown, the developed catalyst reaches levels of ultra-low sulphur content, this is valued below 7 ppm of Sulphur (FIGS. 9 and 11). The CoMoS/support with the hydrodenitrogenant NiMoS/support additive catalyst, shows a performance far above the catalyst of reference (FIGS. 8 and 10), which is due to the formation of type II sites, forming a nanocatalyst, highly dispersed in the support (FIGS. 13 and 14).

1-6. (canceled)

7. A method for producing a catalyst for deep hydro-desulfurization of hydrocarbons, the method comprising the steps of:
mixing:
a compound including cobalt, molybdenum, sulphur (CoMoS) supported on a nanostructured mesoporous support based on SiO₂ and modified with metal oxides selected from the group consisting of Al₂O₃, ZrO₂, TiO₂, and mixtures thereof; and
a hydrodenitrogenant additive including nickel, molybdenum and sulphur (NiMoS) supported on a nanostructured mesoporous support based on SiO₂ and modified with metal oxides selected from the group consisting of Al₂O₃, ZrO₂, TiO₂, and mixtures thereof.

8. A method for producing a catalyst for deep hydro-desulfurization of hydrocarbons, the method comprising the steps of:
mixing:
a compound including cobalt, molybdenum, sulphur (CoMoS) supported on a nanostructured mesoporous support based on SiO₂ and modified with metal oxides selected from the group consisting of Al₂O₃, ZrO₂, TiO₂, and mixtures thereof; and
a hydrodenitrogenant additive including nickel, molybdenum and sulphur NiMoS supported on a nanostructured mesoporous support based on SiO₂ and modified with metal oxides selected from the group consisting of Al₂O₃, ZrO₂, TiO₂ and mixtures thereof;
wherein each one of the nanostructured mesoporous support has a 3D pore structure with pore size diameters of at least 9 nm.

9. The method of claim 7, wherein the nanostructured mesoporous support is modified superficially with a titanium at an atomic proportion between 2.5 and 10%.

10. The method of claim 7, wherein a ratio of the compound to the hydrodenitrogenant additive is from about 50/50 to about 95/5.

11. The method of claim 7, wherein a ratio of the compound to the hydrodenitrogenant additive is from about 70/30 to about 80/20.

12. The method according to claim 7, wherein the catalyst has a reaction rate constant in hydrodesulphurization (HDS) of dibenzothiophene (DBT) of at least 17×10⁻⁷ mole g⁻¹ s⁻¹, when evaluated in a batch reactor at 350° C., 490 psi of hydrogen.

13. The method according to claim 7, wherein the catalyst reduces the total amount of sulphur in a primary light gasoleoum from 16,000 to less than 10 ppm when an activity is evaluated in a PFR under industrial processing conditions.

14. The method according to claim 7, wherein the catalyst has a surface area greater than 350 m²/g.

15. The method according to claim 7, wherein the catalyst has at least a 0.60 cc/g of pore volume.

16. The method according to claim 7, wherein the catalyst has at least a 9 nm pore diameter.

17. A method for producing a catalyst for deep hydro-desulfurization of hydrocarbons, the method comprising the steps of:
mixing:
a compound including cobalt, molybdenum, sulphur (CoMoS) supported on a nanostructured mesoporous support based on SiO₂ and modified with metal oxides selected from the group consisting of Al₂O₃, ZrO₂, TiO₂, and mixtures thereof; and
a hydrodenitrogenant additive including nickel, molybdenum and sulphur (NiMoS) supported on a nanostructured mesoporous support based on SiO₂ and modified with metal oxides selected from the group consisting of Al₂O₃, ZrO₂, TiO₂, and mixtures thereof;
wherein each one of the nanostructured mesoporous support has a 3D pore structure with pore size diameters of at least 9 nm;
wherein the catalyst has an active phase of 16%.
